(19) United States
(12) Patent Application Publication
(10) Pub. No.: US 2024/0368916 A1
(43) Pub. Date: Nov. 7, 2024

(54) A FENCE POST ASSEMBLY WITH AN OPTIONAL ANCHORING DEVICE AND METHOD OF MANUFACTURE THEREOF

(71) Applicant: Phillip Leadbeatter, Torquay (AU)

(72) Inventor: Phillip Leadbeatter, Torquay (AU)

(21) Appl. No.: 18/638,174

(22) Filed: Apr. 17, 2024

Related U.S. Application Data
(63) Continuation-in-part of application No. 18/142,646, filed on May 3, 2023.

(51) Int. Cl. E04H 17/22; E04H 17/00

(52) U.S. Cl. CPC E04H 17/22; E04H 17/017

(57) ABSTRACT

A fence post assembly for enclosing an exterior surface of a galvanized fence post with insulation to reduce deterioration due to oxidation includes the steps of coating a fence post with an anti-corrosion solution to prevent corrosion to the fence post due to oxidation. The fence post extends into an insulation sleeve such that the exterior surface of the fence post is completely enclosed within the insulation sleeve. A standing member fastens to the fence post and is positioned adjacent to a bottom end of the fence post. The bottom end and the standing member insert into a ground surface to frictionally anchor the fence post in ground surface.

### CROSS-REFERENCE TO RELATED APPLICATIONS

This Continuation-in-part application claims priority to Non-provisional U.S. patent application Ser. No. 18/142,646, entitled METHOD FOR PREVENTING CORROSION TO AN IRON ALLOY POST, filed 3 May 2023. This application is herein incorporated by reference in their entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to methods for preventing corrosion and more particularly pertains to a new method for preventing corrosion for enclosing an exterior surface of a galvanized fence post with insulation to reduce deterioration due to oxidation. The disclosure also relates to fencing applications which covers domestic, rural and industrial fencing, in which the fencing may include the retention or exclusion of human beings, and all standard fencing and electric fencing of animal, birds, reptiles, and all other native, feral or domestic creatures.

The disclosure also relates to methods of getting more galvanizing to cling to the metal to protect the fence post assembly and that a method of further protection of the fence post assembly having a sleeve covering to the post may be one selected from the group of: a high U.V and low carbon flexible poly, polyurethane, plastic and plastic combinations of product pipe or some other highly durable sleeve covering to the post. This highly durable sleeve may be loose fitting and be able to be sufficiently sealed, in order to protect the rust treated post from liquid substances and outside of the sleeve air, that could likely cause the post to corrode.

There is a long felt need for fulfilling the need for a specialized fence post assembly of durable metal fabrication for metal wire and mesh applications, to keep away a wide variety of feral animals, or to be effective in containing domestic, farm, or ranch-based animals.

### (2) Description of Related Art Including Information Disclosed Under 37 CFR 1.97 and 1.98

The prior art relates to methods for preventing corrosion teaches a variety of methods including coating the iron alloy material with an anti-corrosive solution to prevent deterioration due to oxidation. Known prior art does not teach insulating a coated iron alloy fence post with a sleeve and attaching a stand member thereto that anchors the fence post within a ground surface.

The prior art can also relate to methods of installing star picket fences or T-posts which can be labour intensive and time-consuming. Driving the posts into the ground can be physically demanding, and it requires specialized equipment like a post driver. These star picket fences require regular maintenance, such as tightening wires or replacing damaged posts and they are readily susceptible to rust and corrosion. Star picket fences do not hold up well over time, especially in areas with harsh weather conditions and/or frequent impacts from livestock. Further removing star picket fences can be challenging as installing stem, particularly if the posts have become firmly embedded in the ground over time. While star picket fences can be relatively inexpensive, the labour and equipment used for maintenance and/or installation and costs to replace will make star picket fences less economical in the long run. Further, star picket fences are not suitable for all environments. In particular with rocky or hard soils, installation can be particularly difficult, and the posts can not provide the necessary stability.

### BRIEF SUMMARY OF THE INVENTION

An embodiment of the disclosure meets the needs presented above by generally comprising a method including the steps of coating a fence post with an anti-corrosion solution configured to prevent corrosion to the fence post due to oxidation. The fence post extends into an insulation sleeve such that the exterior surface of the fence post is completely enclosed within the insulation sleeve. A standing member fastens to the fence post and is positioned adjacent to a bottom end of the fence post. The bottom end and the standing member insert into a ground surface to frictionally anchor the fence post in ground surface.

The appealing features of the specialised fence post would be its ease of installation, ease of use, functionality, efficiency, convenience, utility, versatility, durability, and safety. This invention would provide a metal fence post design that would withstand the effects of ground soil embedment and most weather conditions. The durable material construction of the post, unlike those posts produced of timber/wood, light steel, plastics, fiberglass, recycled composite materials etc would aid in easy transportation and handling, would be virtually unbreakable, would not burn, would not be consumed by insect infestation, or affected by harsh UV rays (ultraviolet rays) from the sun.

The material composition of the post, as well as its coating processes, would ensure that the post would be difficult to deteriorate at the ground interfacing area by multiple soil or air effects for a durable and long-lasting fence post installation. The solid metal post construction would also withstand the rigorous demands placed on fence posts by heavy wire and mesh products, and associated weather conditions that can present forces applied to the wire/mesh products and attachment point locations. The invention could save time, money, and labor costs in association with the fence post(s) installation, while eliminating major maintenance requirements typical of common fence posts.

The specialised fence post assembly would be useful to fence installers, landscapers, lawn service providers/contractors, building construction workers, farmers, ranchers, rural stock owners, equipment rental service providers, professional gardeners, home improvement specialists, maintenance personnel, handymen, homeowners, business owners, do-it-yourself (DIY) enthusiasts, or anyone concerned with the security of their property.

The fence post assembly may have a poly-based sleeve for an insulated installation at a low cost, especially for use with any kind of electric fence system and componentry. It can be offered with a winged collar fitted to the post at the bottom portion for gripping purposes in relation to ground soil installation where the soil may be wet or soft and under pressure from flooding or animal contact.

It is also advantageous to have a metal fence post assembly for these wire and mesh applications that can withstand the effects of ground soil compositions and weather conditions that can apply forces to both the fence posts and wire/mesh components.

Preferably, the step of coating a fence post with an anti-corrosion solution configured to prevent corrosion to said fence post due to oxidation further includes said fence post comprising an iron alloy material and said anti-corrosion solution comprising molten zinc, wherein said anti-corrosion solution is configured to react with an exterior surface of said fence post to form a galvanized coat, said exterior surface of said fence post being threaded.

Preferably, the step of extending the fence post into an insulation sleeve such that said exterior surface of said fence post is completely enclosed within the insulation sleeve further includes said insulation sleeve comprising a heat shrink material, wherein said insulation sleeve is heated to shrink and abut continuously against said exterior surface of said fence post such that said fence post is sealed within said insulation sleeve.

Preferably, the step of fastening a standing member to said fence post and being positioned adjacent to a bottom end of the fence post further includes said standing member comprising a winged collar nut, said winged collar nut threadedly engaging with said exterior surface of said fence post.

Another aspect of the present invention may relate to a method for preventing deterioration to fencing due to oxidation comprising the steps of: coating a fence post with an anti-corrosion solution configured to prevent corrosion to said fence post due to oxidation, said fence post comprising an iron alloy material and said anti-corrosion solution comprising molten zinc, wherein said anti-corrosion solution is configured to react with an exterior surface of said fence post to form a galvanized coat, said exterior surface of said fence post being threaded; extending the fence post into an insulation sleeve such that said exterior surface of said fence post is completely enclosed within the insulation sleeve, said insulation sleeve comprising a heat shrink material, wherein said insulation sleeve is heated to shrink and abut continuously against said exterior surface of said fence post such that said fence post is sealed within said insulation sleeve;
fastening a standing member to said fence post and being positioned adjacent to a bottom end of the fence post, said standing member comprising a winged collar nut, said winged collar nut threadedly engaging with said exterior surface of said fence post; and inserting said bottom end and said standing member into a ground surface to frictionally anchor said fence post in ground surface.

Another aspect of the present invention may relate to a method for preventing deterioration to fencing due to oxidation comprising the steps of: extending a fence post into an insulation sleeve such that said exterior surface of said fence post is completely enclosed within the insulation sleeve, said insulation sleeve comprising a heat shrink material, wherein said insulation sleeve is heated to shrink and abut continuously against said exterior surface of said fence post such that said fence post is sealed within said insulation sleeve; and fastening a standing member to said fence post and being positioned adjacent to a bottom end of the fence post, said standing member comprising a winged collar nut, said winged collar nut threadedly engaging with said exterior surface of said fence post; and inserting said bottom end and said standing member into a ground surface to frictionally anchor said fence post in ground surface.

Another aspect of the present invention may relate to a fence post assembly comprising: a threaded metal rod having an exterior surface, wherein the exterior surface has a layer of anti-corrosion coating; a heat-shrink sleeve positioned over the coated exterior surface, wherein when heated, the insulation sleeve abut continuously against the coated exterior surface of the threaded metal rod such that the threaded metal rod is sealed within the heat shrunk sleeve; a standing member fastenable to the threaded metal rod and positioned adjacent to a bottom end of the threaded metal rod, the standing member comprising a winged collar nut threadedly engaging with the exterior surface of the sealed threaded metal rod; wherein the standing member anchors the fence post when the bottom end and the standing member is inserted into a ground.

Another aspect of the present invention may relate to a fence post assembly comprising: a deformed reinforced rod having an exterior surface; a heat-shrink sleeve positioned over the exterior surface, wherein when heated, the insulation sleeve abut continuously against the exterior surface of the deformed reinforced rod such that the deformed reinforced rod is sealed within the heat shrunk sleeve; a standing member fastenable to the threaded metal rod and positioned adjacent to a bottom end of the threaded metal rod, the standing member comprising a winged collar nut threadedly engaging with the exterior surface of the sealed threaded metal rod; wherein the standing member anchors the fence post when the bottom end and the standing member is inserted into a ground.

Another aspect of the present invention may relate to a fence post comprising: a deformed reinforced bar having an exterior surface from a top end to a bottom end;
an anchoring device affixable to a first lower portion and to a diametrically opposed second lower portion of the exterior surface, wherein the first lower portion and the second lower portion is positioned at a predetermined distance from the bottom end; the anchoring device having an isosceles triangular body with an apex at a direction towards the bottom end, wherein the anchoring device is affixed to the exterior surface, the threaded rod passes through the centroid of the body; wherein the anchoring device anchors the fence post at an upright position when the bottom end and the anchoring device are covered by the ground surface.

Preferably, the deformed reinforced rod passes through the centroid of the body, the body is divided into a first tapered winged portion positioned adjacent to the first lower portion, and a second tapered winged portion positioned adjacent to the diametrically opposed second lower portion.

Preferably, the centroid of the body has an aperture, such that the deformed reinforced rod passing through the centroid of the body bifurcates the aperture, in which the bifurcated apertures are adapted to receive earth therethrough when the anchoring device is covered by the ground surface.

Preferably, the aperture has a rectangular profile.

Preferably, the deformed reinforced rod bifurcates the rectangular aperture into a first rectangular aperture profile and a second rectangular aperture profile.

Preferably, deformed reinforced rod is of a material selected from the group of: steel, mild steel, high tensile steel, and stainless steel.

Another aspect of the present invention may relate to a fence post comprising: a deformed reinforced bar having an exterior surface from a top end to a bottom end; an anchoring device having a trapezoidal profile body, wherein the body comprises an elongate collared member defining an aperture from a middle portion of a longer base edge to a middle portion of a shorter base edge of the body, wherein the aperture is adapted to loosely receive the deformed reinforced bar therethrough; and wherein when the deformed reinforced bar is partially embedded to a first predetermined depth in the ground, the anchoring device is positioned at a level between the first predetermined depth and the surface of the ground; such that when the positioned anchoring device is covered by the ground, the anchoring device anchors the fence post at an upright position.

Preferably, the elongate collared member divides the body into a first tapered portion and a second tapered portion, wherein the deformed reinforced bar is received in the aperture therethrough, the first tapered portion is positioned adjacent to a first lower portion, and the second tapered portion is positioned adjacent to a diametrically opposed second lower portion.

Preferably, the centroid of the body has a body aperture, such that the deformed reinforced rod passing through the centroid of the body bifurcates the aperture, in which the bifurcated apertures are adapted to receive earth therethrough when the anchoring device is covered by the ground surface.

Preferably, the body aperture has a rectangular profile.

Preferably, the deformed reinforced bar bifurcates the rectangular aperture into a first rectangular aperture profile and a second rectangular aperture profile.

Preferably, the deformed reinforced bar is of a material selected from the group of: steel, mild steel, high tensile steel, and stainless steel.

Preferably, the deformed reinforced bar is a rod of a first diameter, and wherein the aperture of the elongate collared member has a second diameter, wherein the second diameter is larger than the first diameter.

Preferably, at least one fence wire is affixable between a first fence post and an adjacent second fence post.

Preferably, the fence wire is parallel with respect to the longer base edge of the anchoring device.

Preferably, the plane of the body of the anchoring device faces at a direction transverse to the direction of fence wire affixed between the first fence post and the adjacent second fence post.

Preferably, the at least one fence wire is electric fence wire.

Preferably, the electric fence wire is in electrical connection to an output terminal of an energiser, and wherein a grounding rod is in electrical connection to an earth output terminal of the energiser.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a method for preventing corrosion to an iron alloy post according to an embodiment of the disclosure.

FIG. 2 is a detail in-use view of an embodiment of the disclosure.

FIG. 3 is a detail isometric view of an embodiment of the disclosure.

FIG. 4 is a detail in-use view of an embodiment of the disclosure.

FIG. 5 is a detail isometric view of an embodiment of the disclosure.

FIG. 6 is a cross-sectional view of an embodiment of the disclosure taken along Line 6-6 of FIG. 5.

FIG. 7 is a detail view of an embodiment of the disclosure taken from Magnified Circle 7 of FIG. 6.

FIG. 8 is a detail isometric view of an embodiment of the disclosure.

FIG. 9 is an in-use view of embodiment of the disclosure.

FIG. 10 is an in-use view of an embodiment of the disclosure.

FIG. 11A is a perspective view of a deformed reinforced bar or rod with a trapezoidal body as an anchoring device loosely collared to a bottom portion of the rod, in which the trapezoidal body has a rectangular aperture at the centroid of the anchoring device body.

FIGS. 11B and 11C are different perspective views of FIG. 11A.

FIG. 12A is a perspective view of a deformed reinforced bar or rod with a trapezoidal body as an anchoring device loosely collared to a bottom portion of the rod.

FIGS. 12B and 12C are different perspective views of FIG. 12A.

FIG. 13A is a perspective view of a deformed reinforced bar or rod with a triangular body as an anchoring device loosely collared to a bottom portion of the rod, in which the triangular body has a rectangular aperture at the centroid of the anchoring device body.

FIGS. 13B and 13C are different perspective views of FIG. 13A.

FIG. 14A is a perspective view of a deformed reinforced bar or rod with a triangular body as an anchoring device loosely collared to a bottom portion of the rod.

FIG. 15A is an in-use view of an embodiment of the disclosure, in which the bottom portion of the deformed reinforced rod is sleeved for added corrosion protection with the anchoring device loosely engaging with the rod beneath the ground, in which the positioned at a predetermined height of the rod such that the long base edge of the anchoring device is level with the surface of the ground.

FIG. 15B is a magnified view of the circled region of FIG. 15A showing the sleeved rod through the collared member of the anchoring device.

FIG. 16 is an in-use view of another embodiment of the disclosure, in which the specialised fence post assembly is suitable to use as an electric fence, where at least one level of parallel electric wire is affixable to the sleeved deformed reinforced rod above the ground while the anchoring device is positioned to sleeve deformed reinforced rod beneath the surface of the ground. The long base edge of the anchoring element is parallel to the direction of the electric wire such that the trapezoidal or triangular body of the anchoring device is facing towards the enclosure.

### DETAILED DESCRIPTION OF THE INVENTION

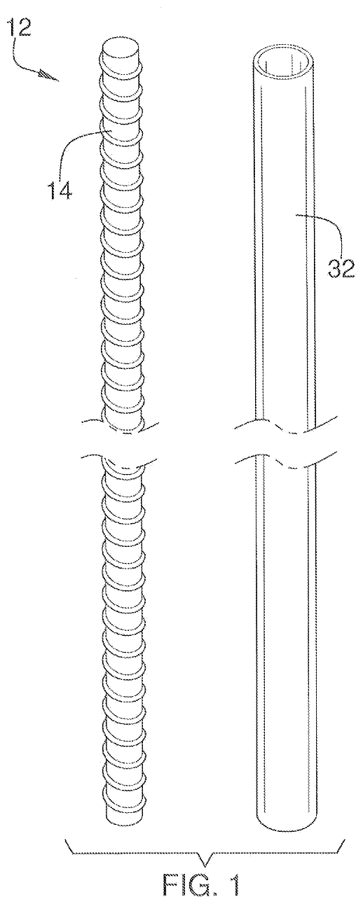

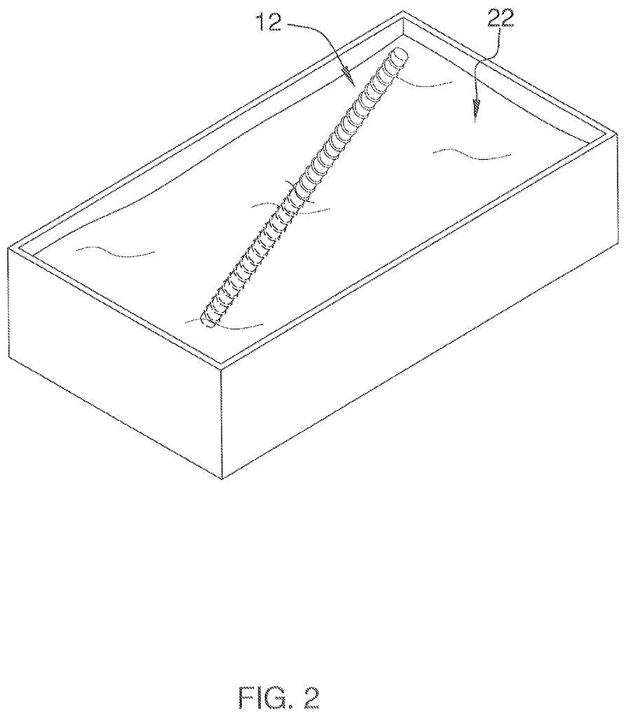

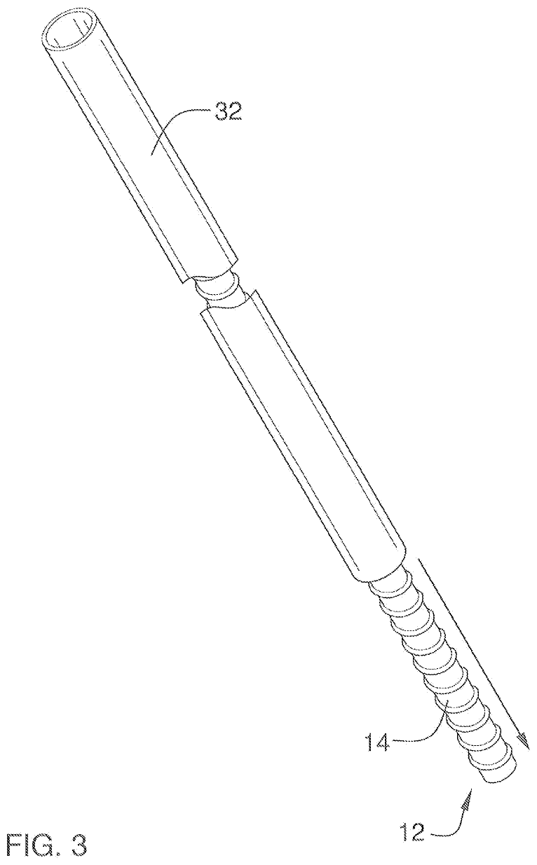

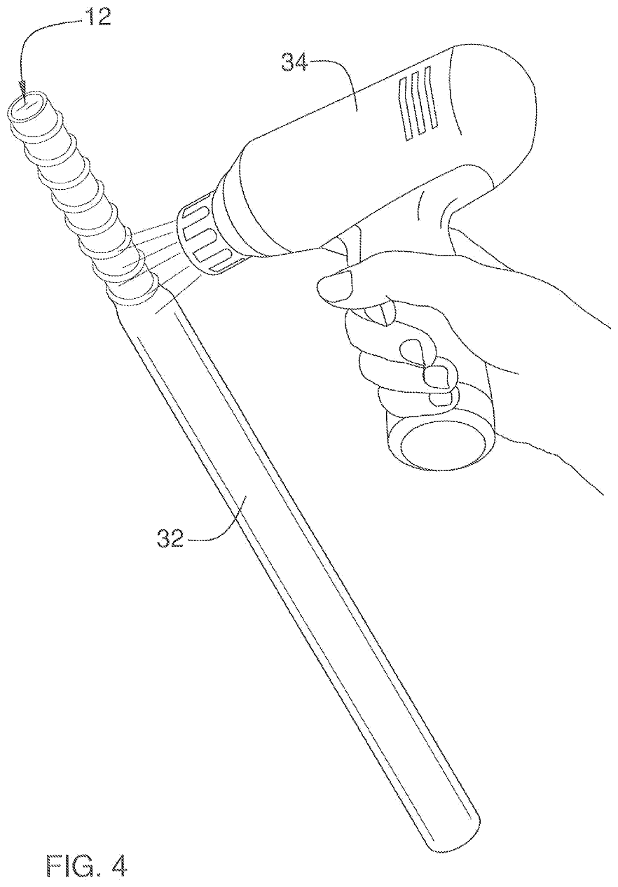

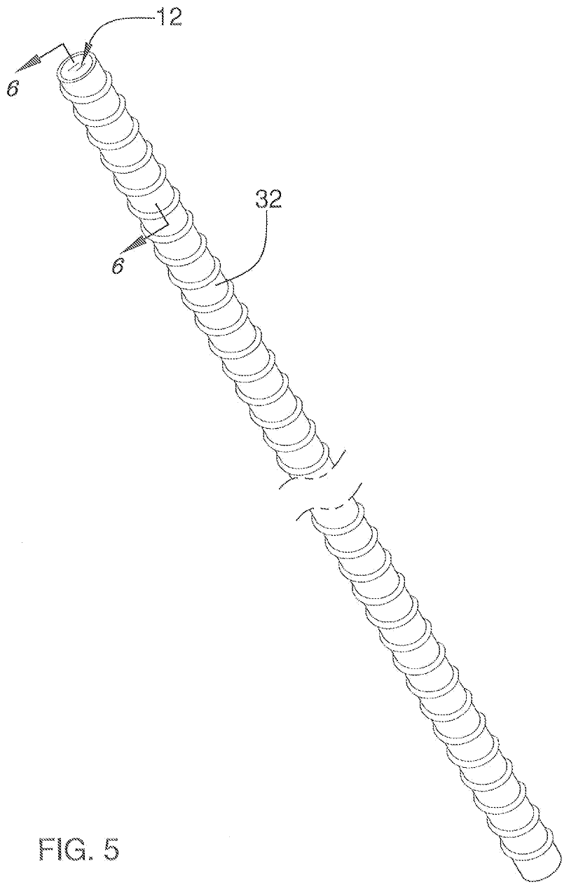

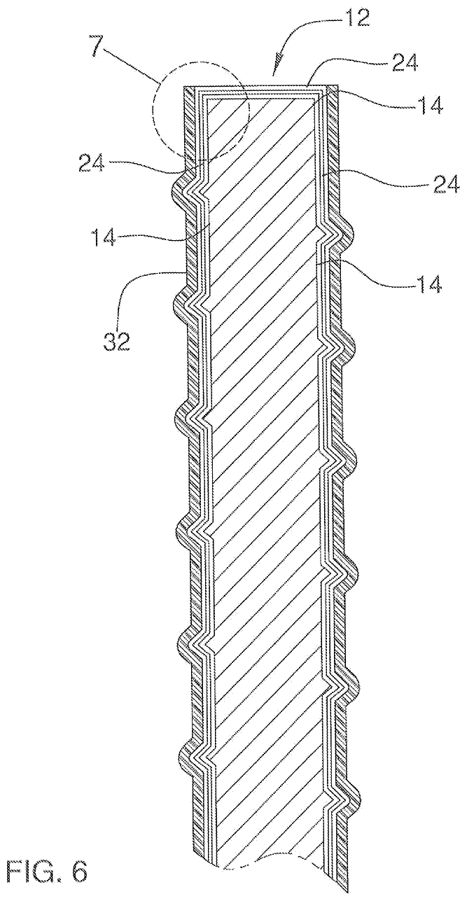

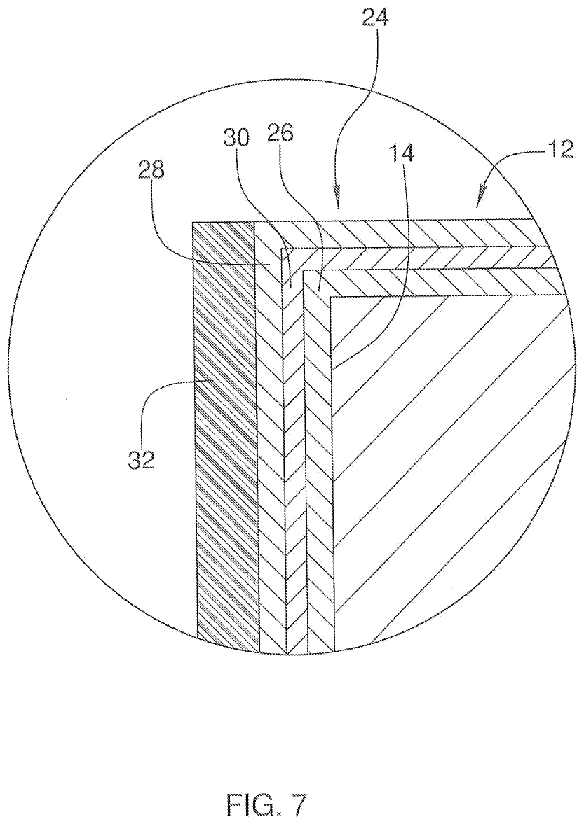

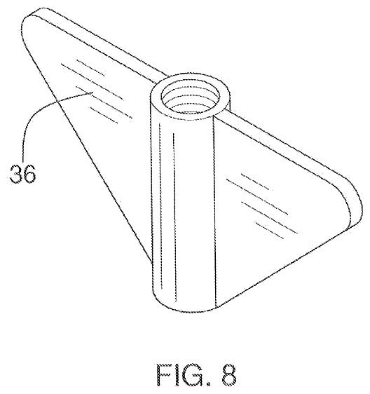

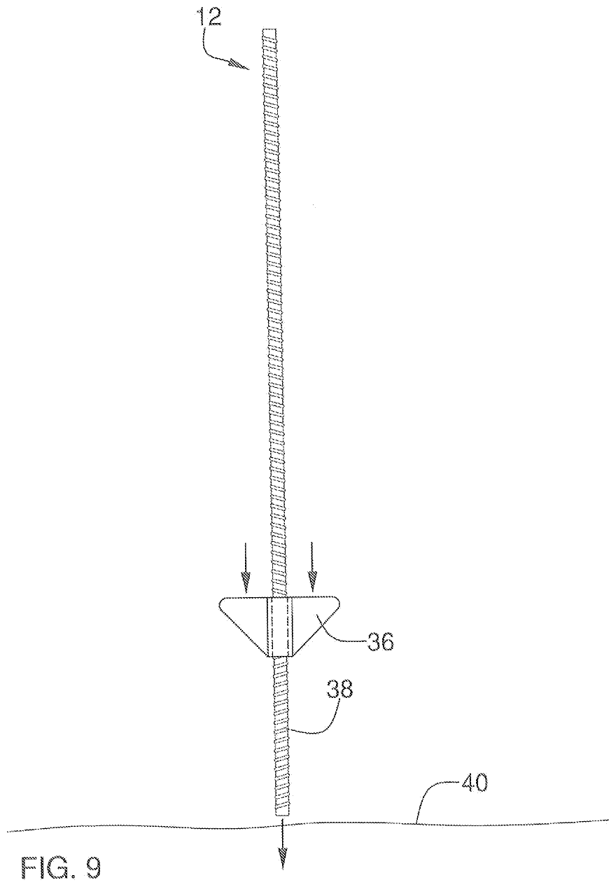

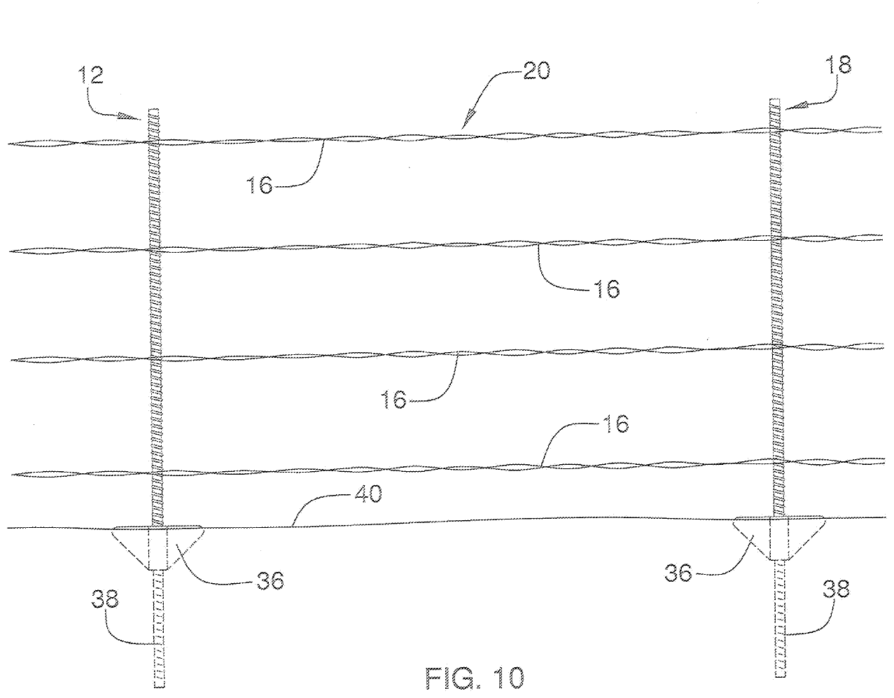

With reference now to the drawings, and in particular to FIGS. 1 through 10 thereof, a new method for preventing corrosion embodying the principles and concepts of an embodiment of the disclosure and generally designated by the reference numeral 10 will be described.

As best illustrated in FIGS. 1 through 10, the method for preventing corrosion to an iron alloy post 10 generally comprises a fence post 12 comprising an iron alloy material. The iron alloy material is configured to deteriorate over a period of time due to oxidation. The fence post 12 is typically a steel rebar, wherein an exterior surface 14 of the fence post 12 is threaded with male threads. The fence post assembly 12 may be one selected from the group of: a round deform bar 13, reo bar 13 (or reinforcing bar), and plain steel rod 13, in both mild, or higher tensile or stainless steel, stainless steel in pipe and rod. The fence post assembly 12 when used as a fence or trellis post 12 or in landscaping and garden environments as a retaining wall or garden edge post 12. Alternatively, the fence post assembly 12 may be a T-post or any other conventional fence post 12. The fence post assembly 12 attaches by lateral rails 16 to at least one other post assembly 18 to form a fence line 20. The bar sizes may range from a minimum of 2 mm diameter with no limit on the upper diameter or the length of the steel bar.

To slow down the oxidation and rusting process of the bar 13 made of a steel material is to cover with a coating that could assist in the prevention or slowing down the oxidisation and rusting process. It may be appreciated that there is no coating limit on how thick the coating of the aforementioned coverings may be or as to how many layers or coatings that can be applied. It may also be appreciated that an embodiment of the invention covers the application of several different types of coatings being applied one on top of the other or blended prior to application to the fence post 12. An anti-corrosion solution 22 may be applied to the fence post 12 and is configured to prevent corrosion to the fence post 12 due to oxidation. The anti-corrosion solution 22 typically comprises molten zinc, wherein the anti-corrosion solution 22 is configured to react with the exterior surface 14 of the fence post 12 to form a galvanized coat 24. The galvanized coat 24 is a zinc-iron alloy that covers the exterior surface 14 of the fence post 12. The fence post 12 is submerged into the anti-corrosion solution 22 and reacts with the anti-corrosion solution 22 over a time span typically from 4 minutes to 5 minutes. The galvanized coat 24 formed on the exterior surface 14 of the fence post 12 typically includes an inner layer 26 positioned adjacent to the exterior surface 14 of the fence post 12, an outer layer 28, and a center layer 30 positioned between the inner 26 and outer 28 layers. The inner layer 26 typically contains between 8% to 12% iron. The center layer 30 typically contains between 4% to 8% iron. The outer layer 28 typically contains 100% zinc. In one alternative, the anti-corrosion solution 22 may comprise a rust inhibitor paint that is typically applied on using a paint brush. In another embodiment, the anti-corrosion solution 22 may comprise at least one selected from the group of: Standard and rust inhibitor paint and or oils, both new and recycled, including all known petrochemical blends and composite blends available in this type of coating, tar, urethane, plastic blends, or any other anti-corrosive material which may be one but is not limited to from the group of: tubes, pipes, electrical wire coverings, wood, wood plastic combinations, poly and propylene, concrete and/or concrete and glass or fibreglass slurry in its many and varied forms.

An insulation sleeve 32 encloses the exterior surface 14 of the fence post 12. The insulation sleeve 32 comprises a heat shrink material, comprising a plastic material colloquially referred to as “shrink wrap.” The insulation sleeve 32 is heated to shrink and abut continuously against the exterior surface 14 of the fence post 12 such that the fence post 12 is sealed within the insulation sleeve 32. The insulation sleeve 32 may be heated by a heat emitter 34 such as a heated air blower. The insulation sleeve 32 facilitates preventing deterioration to the fence post 12 having the galvanized coat 24 thereon. In another embodiment, the insulation sleeve 32 may enclose the exterior surface 14 of the fence post 12 not having the galvanized coat 24 thereon. The insulation sleeve 32 may have a thickness typically between 0.5 mm and 3.0 mm after it has been heated forms a seal on the fence post 12.

In another embodiment, the sleeve covering to the post may be one selected from the group of: a high U.V and low carbon flexible poly, polyurethane, plastic and plastic combinations of product pipe or some other highly durable sleeve covering to the post. This highly durable sleeve may be loose fitting and be able to be sufficiently sealed, in order to protect the rust treated post from liquid substances and outside of the sleeve air, that could likely cause the post to corrode. The fitment of this sleeve to an already treated post will advantageously create a massive extension of useful life expectancy to the post. Another advantage of the fitment of this sleeve would also act as an effective insulator for the post when the user may want to run electric current to the fence for assistance in the effective control of any intrusive species.

A standing member 36 fastens to the fence post 12 and is positioned adjacent to a bottom end 38 of the fence post 12. The standing member 36 comprises a winged collar nut having female threads that threadedly engages with the male threads of the exterior surface 14 of the fence post 12. The bottom end 38 and the standing member 36 insert into a ground surface 40 to frictionally anchor the fence post 12 in ground surface 40. In another embodiment, the stand member is removed from the fence post 12 such that the bottom end 38 is inserted into the ground surface 40 to frictionally anchor the fence post 12 in the ground surface 40. The standing member 36 may be a a spear-shaped collared piece of steel as a ground brace for fence posts. The spear-shaped design of the support plate can effectively anchor the post into the ground, providing greater stability against lateral forces like wind, water pressure, and animal impact. This enhanced stability can advantageously reduce the risk of the fence leaning or falling over. Another advantage that the downward-pointing spear shape has is that it can resist upward forces that might be exerted by wind or water pressure, thereby preventing the fence post from being lifted out of the ground. By extending the brace plate into the ground, the load bearing area is increased, thereby distributing the weight and pressure across a larger surface area. This advantageously prevents localized stress on the post and reducing the risk of failure. In an embodiment, the fitted collar may be loose so it allows for some movement of the support plate taking into account accommodating shifts in the soil caused by environmental factors like freezing and thawing, which may happen inland such as rural areas. The loosely fitted collar may not compromise on the overall structural integrity of the post. Using a tough material such as steel can advantageously ensure that the brace will be able to withstand a range of environmental conditions, including moisture, corrosion, and physical impact, and promotes the longevity of the fence.

This spear-shaped collar can also advantageously be adapted to suit different soil types, ensuring that the brace effectively anchors the post regardless of whether the soil is sandy, clayey, or rocky. The spear-shaped collar can be driven vertically into the ground using relatively simple tool, making installation easier compare to more complex or time-consuming methods. As the support plate provides strong reinforcement against external pressures, and the overall maintenance requirement for the fence could be reduced, thereby saving time and effort over its useful life. As such, this approach is more cost-effective compared to more intricate structural solutions. The relative simplicity of installation can also lead to lower labour costs.

There may be a specialized fence post assembly made from steel, suitable for use with any continuous, multi-level horizontal-oriented wire configurations or open-square wire mesh products. The fence post assembly may be specifically developed for use in fencing and trellis applications. It would aid in the embedded, vertical ground fence post installations, coupled with wire or mesh products to exclude a wide variety of feral animals, or to effectively contain domestic, farm, or ranch-based animals.

Each fence post assembly would be designed to be driven into ground/soil terrain at depth of 400 to 900 millimetres, offering an approximate exposed vertical fence post area, protruding above ground level of 1300 to 2400 millimetres for the attachment of metal wire or mesh products.

Unlike fence posts currently available, made of various other material compositions such as timber or wood, light steel, plastics, fiberglass, recycled composite materials; this fence post may be preferably fabricated of steel or stainless steel and could be mass produced or being widely available worldwide for manufacturing production. And through mass production, it will advantageously lower the retail cost for consumers in any region. This specialized fence post assembly would offer an increased lifespan beyond common fence post materials (insert table/figure), providing the stability required to withstand the weight, tension, and attachment methods of rolled metal wire and mesh products in a tight manner for a consistent fence line, and unraveled for the fence post production. Advantages of this specialized fence post assembly is that it can withstand the effects of ground soil embodiment and all-weather conditions; can be used to contain domestic, farm, or ranch-based animals as well as to keep away a wide variety of feral animals; and offers an improved alternative to fence posts made of wood or plastic. Wooden fence posts can easily rot from insects or over damp or wet conditions underground from the moisture, dew and rain or snow. And plastic fence posts might soften or warp during hotter conditions, and while in cold conditions, they might become brittle and prone to cracking or breaking. Plastic fence posts can have limitations in terms of load-bearing capacity and negatively impacts their suitability for fences that require strong structural support. When plastic fence posts do become damaged, they are not easily repairable as metal posts. If the plastic post needs to be replaced, it can be more challenging to remove plastic posts that have been anchored in the ground.

The specialised fence post assembly is most preferably a deform bar or a ‘reinforcing bar’, and its preferable applications may be as a post for fencing and trellis applications. The deform bar can advantageously be bent or folded to any shape to suit any particular need as required.

The specialised fence post would be preferably round in shape. Depending on the particular use, the dimensions of the post may be of any height/length ratio and any width/diameter ratio. A non-limiting example of the dimension of the post may include a height/length of 1 to 4 meters, and a width/diameter of 4 to 40 millimeters. The deformed bar would be made of steel and the steel could have a material composition comprised of an AISI 4130 low alloy hardened steel, a carbon steel containing molybdenum and chromium as strengthening and toughness agents, or an AISI-S1 steel alloy, which may also comprise a chrome-tungsten steel material base, in which the chrome-tungsten steel material base can advantageously provide optimal manufacturing properties in relation to factoring for at least one of the group of properties: hardness and toughness, heat-resistance (for when the area at which the specialised fence post may be applied may be in a fire prone terrain), weldability, and high-duty shock resistance. As the terrain may also be prone to flooding, it is important to maintain the structural integrity of the specialised fence post that the deformed bar or steel fence post could be finished with a galvanized protective finish, to prevent rust and corrosion. Other various coverings and coatings that could be applied to the unit would include: galvanizing, tar, cold gal paint, and any other potential paint formulation for rust prevention or resistance of up to 150 millimeters in thickness.

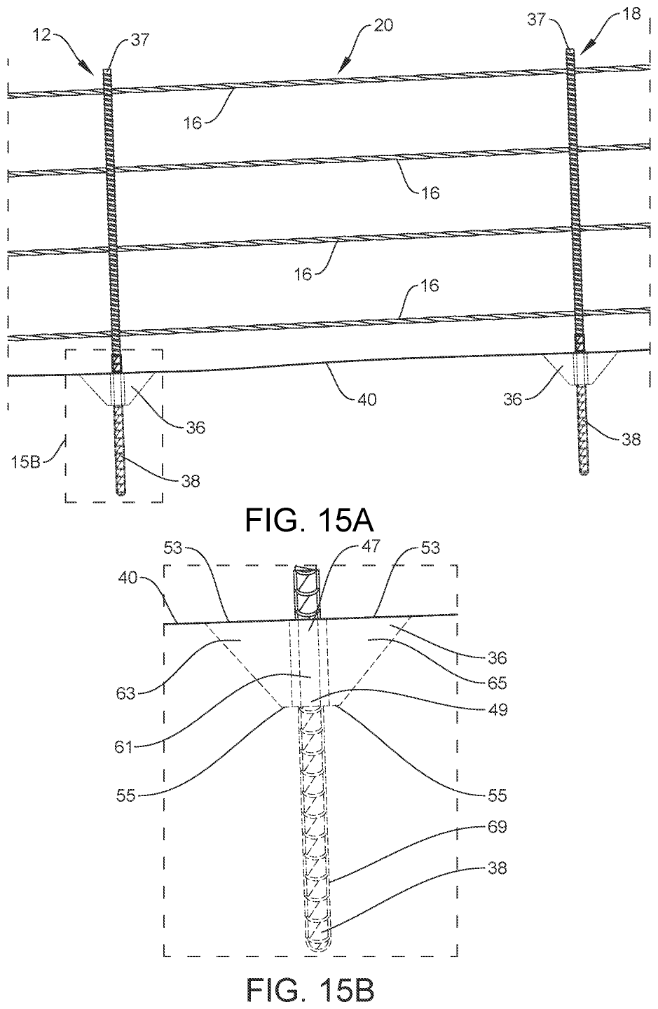

These coverings or coatings could also be applied in multiple layers of the same or different coating types on the same post or trellis. Specific coverings for the specialised fence post could include one from the group of: plastics, urethane, timber, recycled plastics, concrete, wood or plastic combinations, shrink-wrapping, melted plastics, as well as loose sleeve poly or plastic coverings. An example of the post having a covering is shown in FIG. 15. The covering may be at the bottom portion of the post or deformed bar, at which the bottom portion is embedded within ground soil or in contact with the soil of the ground. Different terrains may have different soil acidity or alkalinity, which may range from pH3 to pH10, the covering will further protect the deformed bar or deformed bar with a galvanised protective finish and/or with a shrink-wrapping from caustic erosion caused by the acidity/alkalinity of the soil. This can advantageously promote longevity in the specialised fence post installation and lifespan, in order to satisfy the intent of the invention.

The specifications in material and coating processes would aim to reduce the common concerns centered around standard-available light steel fence posts penetrated into ground surfaces, where air combined with soil acidity, high sodium levels or salinity, acid sulfides, and/or high alumina, high alkalinity content in the soil, typically cause severe oxidation to these lower-grade steel fence post products.

The finished overall size and shape configuration of the fence post, material composition, dimensions, and fence installation-interface applications would be developed during the design and engineering phases, prior to manufacture. The invention could be designed, engineered, and manufactured similar to fence components or farming implements having functional and material specifications to meet or comply with nationally and internationally recognized testing laboratories to include American-Underwriters Laboratories (UL), European (CE), OSHA™ (Occupational Safety and Health Administration), ETL™ listed Interlek (ETL), and/or ANSI™ (American National Standards Institute) approval/certifications.

There may be provided a collared steel member like the support plate or pressure plate is connected to the post by a collar that is larger than the diameter of the post, which enables the collared member to be easily moved along the length of the threaded rod or post. This collared piece of strong material sits horizontal to the vertical standing threaded rod or post and thus preventing the post from sinking into the ground any further than the user's desired implemented depth into the ground. This ground support plate or pressure plate may be secured to the post in the desired position by a grub screw, pin/clip, glue or twisted wire arrangement for permanently gripping onto the threaded rod or post. This connecting arrangement is advantageously designed to prevent the horizontal plate from sliding up the post after the clamping or connecting mechanism has been securely tightened onto the threaded rod or post.

In use, the fence post 12 is coated with the anti-corrosion solution 22 configured to prevent corrosion to the fence post 12 due to oxidation. The fence post 12 extends into the insulation sleeve 32 such that the exterior surface 14 of the fence post 12 is completely enclosed within the insulation sleeve 32. The standing member 36 fastens to the fence post 12 and is positioned adjacent to the bottom end 38 of the fence post 12. The bottom end 38 and the standing member 36 insert into the ground surface 40 to frictionally anchor the fence post 12 in ground surface 40. The fence post 12 attaches by lateral rails 16 to at least one other post 18 to form the fence line 20.

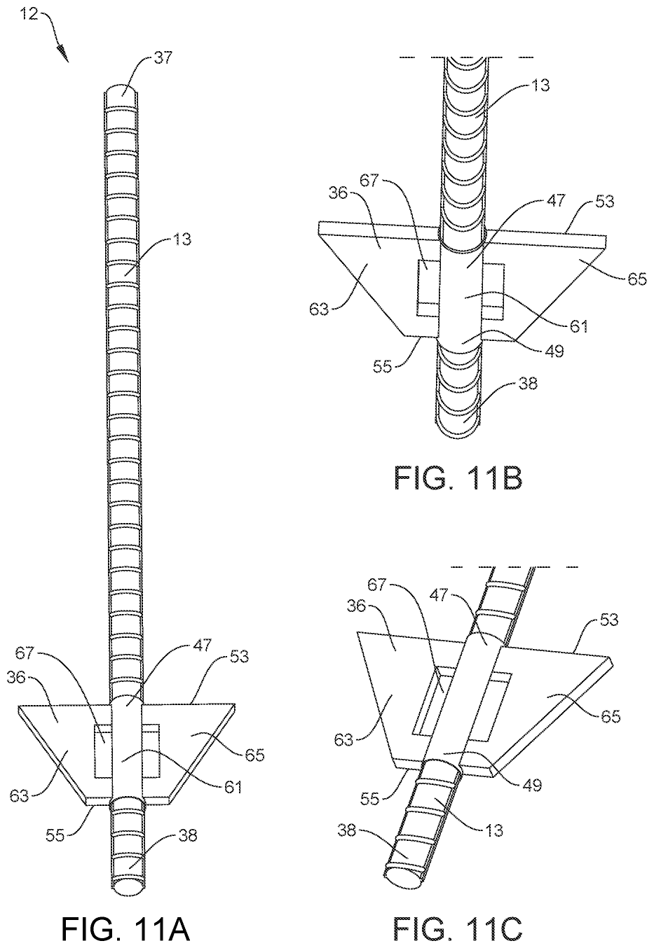

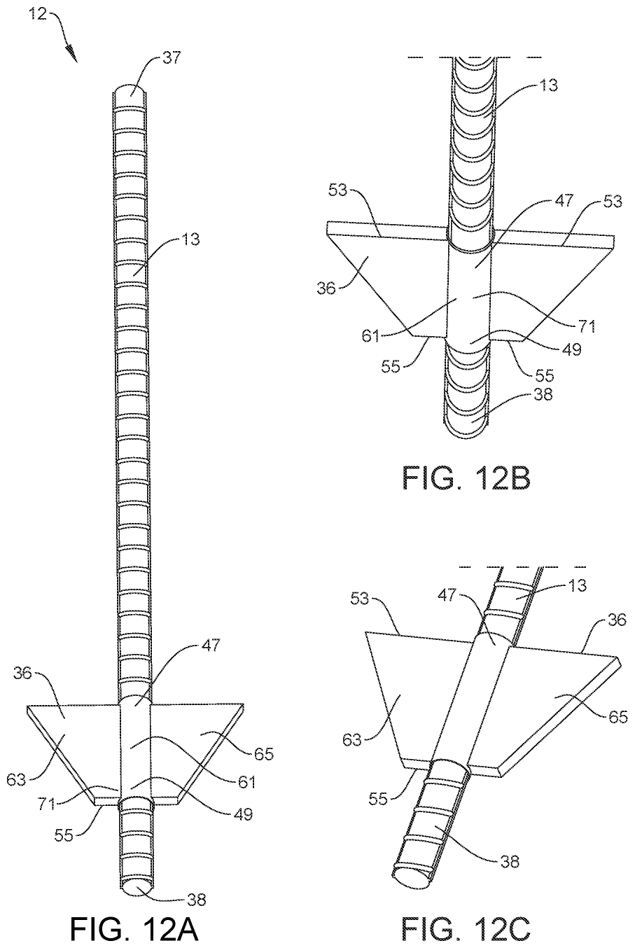

In an embodiment of the present invention, as shown in FIGS. 11 and 12, there may be a metal fence post assembly 12, in which the metal may be chosen from the group of: steel, mild steel, high tensile steel, and stainless steel. The metal fence post assembly 12 may have an exterior surface 14 from a top end 37 to a bottom end 38. An anchoring device 36 or a standing member 36 may be affixable to a first lower portion 41 and to a diametrically opposed second lower portion 43 of the exterior surface 14. The first lower portion 41 and the second lower portion 43 may be positioned at a predetermined distance from the bottom end 38.

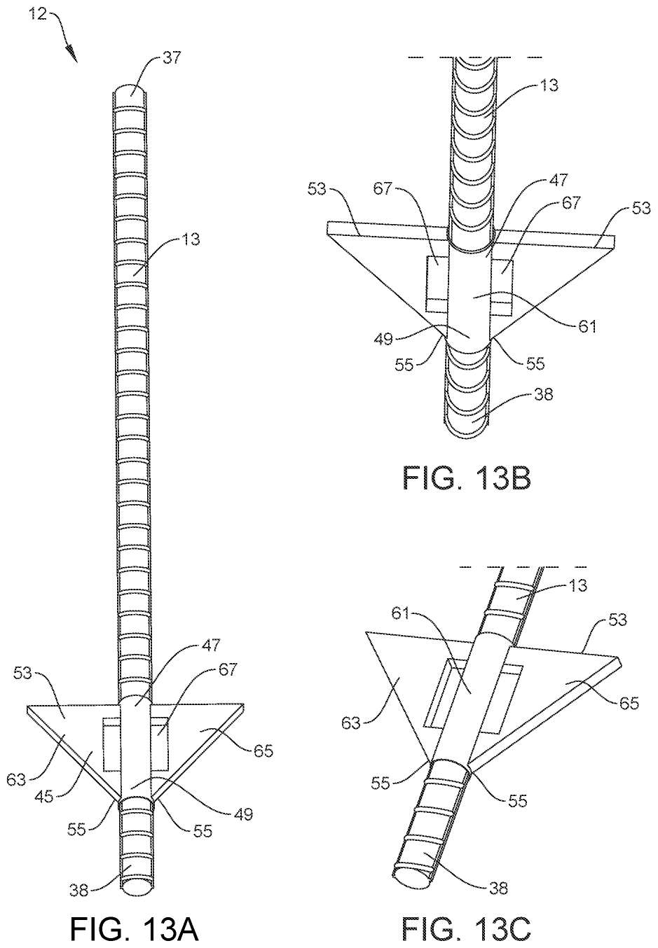

The anchoring device 36 or anchoring member 36 may also be a metal material and may be similarly chosen from the group of: steel, mild steel, high tensile steel, and stainless steel. As shown in FIGS. 13A to 13C, the anchoring device 36 may have an isosceles triangular body with an apex at a direction towards the bottom end 38, wherein the anchoring device 36 is affixed to the exterior surface, the threaded rod passes through the centroid of the body. In another embodiment, as shown in FIGS. 11A to 11C, the anchoring device 36 may have a trapezoidal body with the short base positioned between the long base and the bottom of the deformed reformed bar. In both embodiments, the anchoring device 36 comprises an upper collared portion 47 and a lower collared portion 49. The upper collared portion 47 and the lower collared portion 49 each have a collar diameter greater than the diameter of the deformed reinforced bar 13 such that the anchoring device 36 is loose fitting.

While the anchoring device 36 is loosely fitted to the deformed reinforced bar, the loosely fitted anchoring device with the post may anchor the fence post assembly 18 at an upright position when the bottom end 38 and the anchoring device 36 are covered by the ground surface, wherein when the anchoring device 36 is embedded in the ground soil, the fence post assembly advantageously resists tilting when a pushing force is pushed transverse to the plane of the body of the anchoring device 36.

When installing this fence post assembly, the person may first dig a hole of a predetermined depth in the ground. The deformed reinforced bar 13, which may be galvanised and/or sleeved is then placed in the hole such that the bottom portion of the bar 38 is to be embedded in the soil of the ground 40 when the hole is filled up, and the top portion of the bar 51 is above the ground to a predetermined height. After partially filling up the hole, the anchoring device 36 can fall into place by fitting the lower collared portion over the top of the deformed reinforced bar first and when it is passed therethrough, the top of the deformed reinforced bar 37 then passes therethrough the upper collared portion 47 of the anchoring device 36. The anchoring device 36 then falls towards the bottom portion of the rod 38 until it reaches the partially filled hole. This then sets the anchoring device's 36 positioning at the bottom portion of the deformed reinforced bar 38, and once the anchoring device 36 is positioned within the ground, the hole is then filled up such that the long base 53 of the body of the anchoring device is level to the surface of the ground 40.

The height at which the deformed reinforced bar 51 is above ground may be determined by whether the animal to be kept within the fenced area cannot leap over and also in consideration of feral animals to be kept out such that the feral animals to be excluded cannot go within the fenced area.

In another embodiment, as shown in FIGS. 11A to 11C, the anchoring device 36 may have a trapezoidal body 45 with the short base 55 positioned between the long base 53 and the bottom of the deformed reformed bar 38 similar to the embodiment as shown in FIGS. 12A to 12C. The anchoring device 36 comprises an upper collared portion 47 and a lower collared portion 59. The upper collared portion 47 and the lower collared portion 59 each have a collar diameter greater than the diameter of the deformed reinforced bar 12 such that the anchoring device 36 is loose fitting when the deformed reinforced rod passes through the centroid 61 of the body 45 through the upper collar portion 47 and the lower collar portion 49 of the anchor device 36, the body 45 is divided into a first tapered winged portion 63 and a second tapered winged portion 65 positioned adjacent to the diametrically opposed second lower portion. The first tapered winged portion 63 may be adjacent to the first lower portion of the exterior surface 14, and the second tapered winged portion 65 may be adjacent to the diametrically opposed second lower portion of the exterior surface 14 of the deformed reinforced rod 13. The centroid 61 of the body 45 may have an aperture 67 such that when affixed, the threaded rod passing through the centroid 61 of the body 45 bifurcates the aperture 67, in which the bifurcated apertures are adapted to receive earth therethrough when the anchoring device 36 is covered by the ground surface 40. The advantage of the apertures 67 able to receive earth therethrough which allows the weight of the earth to add a vertical stabilising weight to the anchoring device 36.

As shown in FIGS. 11A to 11C, the centroid 61 of the body 45 of the anchoring device 36 may have an aperture 67 of a rectangular profile, for example. It may be appreciated that any other shape profiles may be used. The deformed reinforced rod 13 may be a bifurcating member which bifurcates the rectangular aperture 61 into a first rectangular aperture profile and a second rectangular aperture profile. In another embodiment, as shown in FIGS. 12A to 12C, there is no aperture and the profile may be a trapezoid.

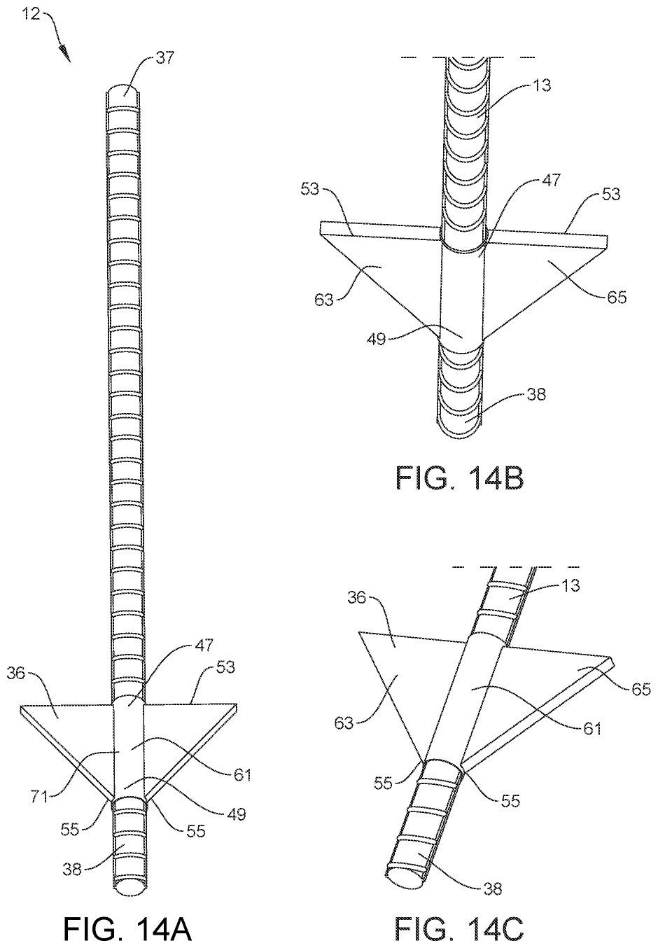

In another embodiment, as shown in FIGS. 14A to 14C, the body 45 of the anchoring device 36 may be an isosceles triangle with an apex pointing towards the bottom of the deformed reinforced bar, there is an aperture of a rectangular profile, for example. The anchoring device 36 comprises an upper collared portion 47 and a lower collared portion 49. The upper collared portion 47 and the lower collared portion 49 each have a collar diameter greater than the diameter of the deformed reinforced bar 13 such that the anchoring device 36 is loose fitting when the deformed reinforced rod 13 passes through the centroid 61 of the body 45 through the upper collar portion 47 and the lower collar portion 49 of the anchor device 36, the body 45 is divided into a first tapered winged portion 63 and a second tapered winged portion 65 positioned adjacent to the diametrically opposed second lower portion. The first tapered triangular portion 63 may be adjacent to the first lower portion of the exterior surface 14, and the second tapered triangular portion 65 may be adjacent to the diametrically opposed second lower portion of the exterior surface 14 of the deformed reinforced bar or rod 13.

As shown in FIGS. 13A to 13C, the centroid 61 of the body 45 of the anchoring device 36 may have an aperture 67 of a rectangular profile, for example. It may be appreciated that any other shape profiles may be used. The deformed reinforcing bar 13 may be a bifurcating member which bifurcates the rectangular aperture into a first rectangular aperture profile and a second rectangular aperture profile.

In another embodiment, as shown in FIGS. 15A and 15B, the bottom of the deformed reinforcing bar is sleeved 69 for protecting the bottom portion 38 of the bar 13 when embedded, in which the sleeve 69 may be of a poly material. Even when sleeved, the diameter of the sleeved rod is still smaller than the aperture of the elongate collared member 71 of the anchoring device 36 so that the anchoring device 36 is loosely fitted to a desired predetermined distance from the bottom portion 38 of the rod 13.

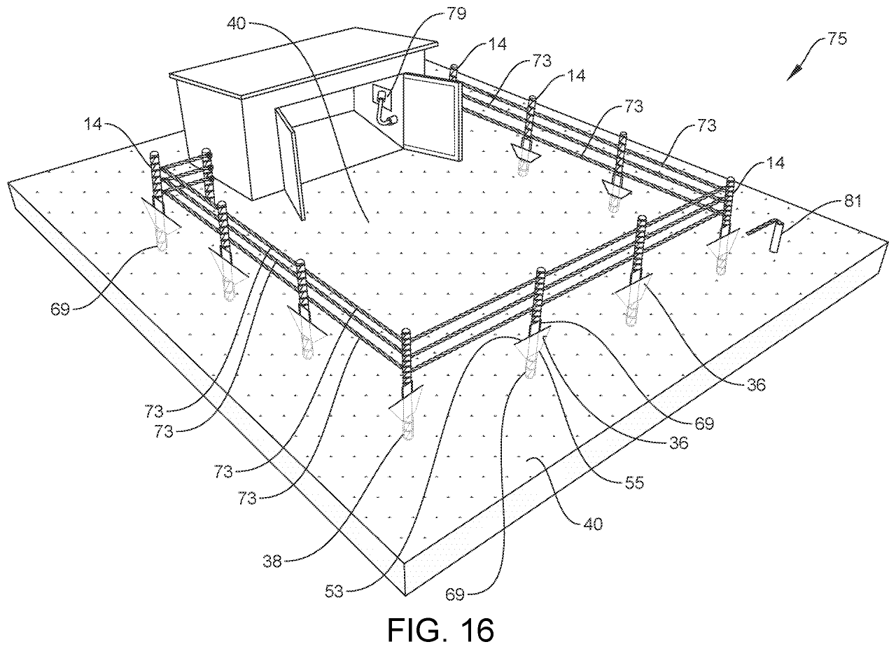

In another embodiment, the fence post assembly 12 may be suitable to be used for electric fencing. As shown in FIG. 16, which shows a non-limiting example of a three level electrical wires 73 linked up to a group of fence posts 18 forming a perimeter 75 or closed circuit. The fence post 18 of this embodiment can be a deformed reinforcing bar 13 with an anchoring device 36 that may be galvanised having an insulating non-conductive heat-shrunk sleeve 77 to the exterior surface 14 of the deformed reinforcing bar 13. The at least one level of electric wire 73 may be affixed around the poly sleeve 77 or non-conductive sleeve 77 and the at least one level of electric wire 73 is in electrical connection to the adjacent deformed reinforcing bar 13. When the desired perimeter is set up with levels of electrical wire 73 spaced at a predetermined height parallel with respect to each other, the electrical wires 73 are in electrical connection via an electrical lead to an output terminal 83 of an energiser 79. A grounding rod 81 positioned beyond the enclosed perimeter may be in electrical connection an earth output terminal 85 of the energiser 79. Depending on the livestock threshold for electrical shock as a deterrent, the energiser 79 may be of a predetermined voltage for delivering a mild electrical shock but not damage the livestock when the livestock comes in contact with the electrical wire.

The following voltage threshold may be a guide to the animal or livestock requirements:

For beef cattle, a preferred voltage range may be between 2 kV to 3 kV, while dairy cattle may be 2 kV or less. Beef cattle may require higher voltage as lower voltages may not be too much a deterrent as beef cattle are generally more aggressive.

For horses, a preferred voltage range may be 2 kV to 3 kV;

For Llamas, Sheep and Goats, as their thick coats may insulate from electric shocks so the preferred voltage range may be between 4 kV to 5 kV;

For Deer and Elk, the preferred voltage range may be 4 kV to 5 kV. Since deer and elk may be able to jump higher than most other animals, a high fence, which may be above head height is recommended. Also spacing levels of electric wires close enough so as to prevent the head of the deer or elk to go between the levels of wires.

For pigs, a preferred voltage may be around 2 kV.

While the above may be preferred to keep the livestock or preferred animals within the set perimeter, another consideration for voltage and style of fencing as to how low the level of wires are spaced apart is also dependent on the feral animals or nuisance animals that may want to enter the perimeter zone.

As nuisance pests may require higher voltage thresholds, an electric fence configuration (not shown) may be to have an inner electric fence area of a predetermined voltage threshold range generally lower than an outer electric fence area of a predetermined voltage to keep feral animals out, while the inner electric fence is for keeping livestock in.

Generally for in consideration of costs, there may just be an electric fence perimeter and the voltage can be dynamically adjusted such that when the livestock are back in the shed and is not likely to contact the electric fence, the voltage can be increased so keep nuisance pests/animals out.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fence post assembly comprising:
a deformed reinforced bar having an exterior surface from a top end to a bottom end;
an anchoring device having a trapezoidal profile body, wherein the body comprises an elongate collared member defining an aperture from a middle portion of a longer base edge to a middle portion of a shorter base edge of the body, wherein the aperture is adapted to loosely receive the deformed reinforced bar therethrough; and
wherein when the deformed reinforced bar is partially embedded to a first predetermined depth in the ground, the anchoring device is positioned at a level between the first predetermined depth and the surface of the ground; such that when the positioned anchoring device is covered by the ground, the anchoring device anchors the fence post at an upright position.

2. The fence post assembly according to claim 1, wherein the elongate collared member divides the body into a first tapered portion and a second tapered portion, wherein the deformed reinforced bar is received in the aperture therethrough, the first tapered portion is positioned adjacent to a first lower portion, and the second tapered portion is positioned adjacent to a diametrically opposed second lower portion.

3. The fence post assembly according to claim 1, wherein the centroid of the body has a body aperture, such that the threaded rod passing through the centroid of the body bifurcates the aperture, in which the bifurcated apertures are adapted to receive earth therethrough when the anchoring device is covered by the ground surface.

4. The fence post assembly according to claim 3, wherein the body aperture has a rectangular profile.

5. The fence post assembly according to claim 4, wherein the deformed reinforced bar bifurcates the rectangular aperture into a first rectangular aperture profile and a second rectangular aperture profile.

6. The fence post assembly according to claim 5, wherein the deformed reinforced bar is of a material selected from the group of: steel, mild steel, high tensile steel, and stainless steel.

7. The fence post assembly according to claim 1, wherein the deformed reinforced bar is a rod of a first diameter, and wherein the aperture of the elongate collared member has a second diameter, wherein the second diameter is larger than the first diameter.

8. The fence post assembly according to claim 1, wherein at least one fence wire is affixable between a first fence post and an adjacent second fence post.

9. The fence post assembly according to claim 8, wherein the fence wire is parallel with respect to the longer base edge of the anchoring device.

10. The fence post assembly according to claim 9, wherein the plane of the body of the anchoring device faces at a direction transverse to the direction of fence wire affixed between the first fence post and the adjacent second fence post.

11. The fence post assembly according to claim 10, wherein the at least one fence wire is electric fence wire.

12. The fence post assembly according to claim 11, wherein the electric fence wire is in electrical connection to an output terminal of an energiser, and wherein a grounding rod is in electrical connection to an earth output terminal of the energiser.

13. A fence post assembly comprising:
a deformed reinforced bar having an exterior surface, wherein the exterior surface has a layer of anti-corrosion coating;
a heat-shrink sleeve positioned over the coated exterior surface, wherein when heated, the insulation sleeve abut continuously against the coated exterior surface of the deformed reinforced bar such that the deformed reinforced bar is sealed within the heat shrunk sleeve; and
a standing member fastenable to the deformed reinforced bar and positioned adjacent to a bottom end of the threaded metal rod, the standing member comprising a winged collar nut threadedly engaging with the exterior surface of the sealed deformed reinforced bar; wherein the standing member anchors the fence post when the bottom end and the standing member is inserted into a ground.

14. A fence post assembly comprising:
a deformed reinforced bar having an exterior surface; and
a heat-shrink sleeve positioned over the exterior surface, wherein when heated, the insulation sleeve abut continuously against the exterior surface of the deformed reinforced bar such that the deformed reinforced bar is sealed within the heat shrunk sleeve; a standing member fastenable to the threaded metal rod and positioned adjacent to a bottom end of the deformed reinforced bar, the standing member comprising a winged collar nut threadedly engaging with the exterior surface of the sealed deformed reinforced bar; wherein the standing member anchors the fence post when the bottom end and the standing member is inserted into a ground.
